(19) United States
(12) Patent Application Publication
(10) Pub. No.: US 2014/0307054 A1
(43) Pub. Date: Oct. 16, 2014

(54) AUTO FOCUS METHOD AND AUTO FOCUS APPARATUS

(71) Applicant: Altek Semiconductor Corp., Hsinchu City (TW)

(72) Inventors: Wen-Yan Chang, Miaoli County (TW); Yu-Chen Huang, Hsinchu County (TW); Hong-Long Chou, Hsinchu County (TW); Chung-Chia Kang, Tainan City (TW)

(73) Assignee: Altek Semiconductor Corp., Hsinchu City (TW)

(21) Appl. No.: 13/899,586

(22) Filed: May 22, 2013

(30) Foreign Application Priority Data
Apr. 11, 2013 (TW) 102112875

(51) Int. Cl. H04N 13/02

(52) U.S. Cl. CPC H04N 13/0271
USPC 348/47

(57) ABSTRACT

An auto focus (AF) method adapted to an AF apparatus is provided. The AF method includes following steps. A target object is selected and photographed by a first image sensor and a second image sensor to generate a first image and a second image. A procedure of three-dimensional (3D) depth estimation is performed according to the first image and the second image to generate a 3D depth map. An optimization process is performed on the 3D depth map to generate an optimized 3D depth map. A piece of depth information corresponding to the target object is determined according to the optimized 3D depth map, and a focusing position regarding the target object is obtained according to the pieces of depth information. The AF apparatus is driven to execute an AF procedure according to the focusing position. Additionally, an AF apparatus is provided.

### CROSS-REFERENCE TO RELATED APPLICATION

This application claims the priority benefit of Taiwan application serial no. 102112875, filed on Apr. 11, 2013. The entirety of the above-mentioned patent application is hereby incorporated by reference herein and made a part of this specification.

### BACKGROUND OF THE INVENTION

1. Field of the Invention

The present invention generally relates to an auto focus (AF) technique, and more particularly, to an AF method and an AF apparatus adopting a stereoscopic image processing technique.

2. Description of Related Art

A digital camera usually has a very complicated mechanical structure and enhanced functionality and operability. Besides the user's photographing skill and the surrounding environment, the auto focus (AF) system in a digital camera also has a great impact on the quality of images captured by the digital camera.

Generally, an AF technique refers to that a digital camera moves its lens to change the distance between the lens and a object to be photographed and repeatedly calculates a focus evaluation value (referred to as a focus value thereinafter) of the captured image according to the position of the lens until the maximum focus value is determined. To be specific, the maximum focus value of a lens allows a clearest image of the object to be photographed at the current position of the lens. However, in the hill-climbing technique or regression technique adopted by existing AF techniques, every focusing action requires the lens to be continuously moved and multiple images to be captured to search for the maximum focus value. Thus, it is very time-consuming. Besides, when a digital camera moves its lens, the lens may be moved too much therefore has to be moved back and forth. As a result, a phenomenon named “Breathing” may be produced. The phenomenon of breathing refers to the change of angle of view of a lens when shifting the focus and therefore destroys the stability of the image.

On the other hand, an AF technique adopting the stereoscopic vision technique for processing images and establishing image three-dimensional (3D) depth information is provided. This AF technique can effectively shorten the focusing time and eliminate the phenomenon of breathing and can increase the focusing speed and image stability therefore becomes increasingly popular in related fields. However, generally speaking, when 3D coordinate position information of each pixel in an image is obtained through image processing of the present stereoscopic vision technique, the position of each point in the image cannot be determined precisely. Since it is difficult to identify relative depth or precisely determine depth information of each point in a texture-less or flat area, “holes” may be produced in the 3D depth map. Besides, if this AF technique is applied to a handheld electronic apparatus (for example, a smart phone), to minimize the size of the product, the stereo baseline of the product has to be reduced as much as possible. As a result, precise positioning may become even more difficult and more holes may be produced in the 3D depth map. Moreover, the execution of subsequent image focusing procedures may be affected.

### SUMMARY OF THE INVENTION

Accordingly, the present invention is directed to an auto focus (AF) method and an AF apparatus which offer fast focusing speed and optimal image stability.

The present invention provides an AF method adapted to an AF apparatus. The AF apparatus includes a first image sensor and a second image sensor. The AF method includes following steps. A target object is selected and photographed by the first image sensor and the second image sensor to generate a first image and a second image. A three-dimensional (3D) depth estimation is performed according to the first image and the second image to generate a 3D depth map. An optimization process is performed on the 3D depth map to generate an optimized 3D depth map. A piece of depth information corresponding to the target object is determined according to the optimized 3D depth map, and a focusing position regarding the target object is obtained according to the piece of depth information. The AF apparatus is driven to execute an AF procedure according to the focusing position.

The present invention provides an AF apparatus including a first image sensor, a second image sensor, a focusing module, and a processing unit. The first image sensor and the second image sensor photograph a target object to generate a first image and a second image. The focusing module controls a focusing position of the first image sensor and the second image sensor. The processing unit is coupled to the first image sensor, the second image sensor, and the focusing module. The processing unit performs a procedure of 3D depth estimation on the first image and the second image to generate a 3D depth map and performs an optimization process on the 3D depth map to generate an optimized 3D depth map. The processing unit determines a piece of depth information corresponding to the target object according to the optimized 3D depth map and obtains the focusing position regarding the target object according to the piece of depth information. The focusing module executes an AF procedure according to the focusing position.

According to an embodiment of the present invention, the step of obtaining the focusing position regarding the target object according to the piece of depth information includes following step. A depth table is inquired according to the piece of depth information to obtain the focusing position regarding the target object.

According to an embodiment of the present invention, the step of selecting the target object includes following steps. A click signal for selecting the target object is received from a user through the AF apparatus or an object detecting procedure is executed through the AF apparatus to automatically select the target object and a coordinate position of the target object is obtained.

According to an embodiment of the present invention, the steps of determining the piece of depth information corresponding to the target object according to the optimized 3D depth map and obtaining the focusing position according to the piece of depth information include following steps. A block containing the target object is selected, pieces of depth information of a plurality of neighborhood pixels in the block is read, and a statistical calculation is performed on the pieces of depth information of the neighborhood pixels to obtain a piece of optimized depth information of the target object. The focusing position regarding the target object is obtained according to the piece of optimized depth information.

According to an embodiment of the present invention, the AF method further includes following step. An object tracking procedure is executed on the target object to obtain at least one piece of characteristic information and a trajectory of the target object, wherein the piece of characteristic information includes gravity center information, color information, area information, contour information, or shape information.

According to an embodiment of the present invention, the AF method further includes following steps. The pieces of depth information corresponding to the target object at different time are stored into a depth information database. A procedure of displacement estimation is performed according to the pieces of depth information in the depth information database to obtain a depth variation trend regarding the target object.

According to an embodiment of the present invention, the optimization process is a Gaussian smoothing process.

According to an embodiment of the present invention, the AF apparatus further includes a storage unit. The storage unit is coupled to the processing unit and configured to store the first image, the second image, and the depth table. The processing unit inquires the depth table according to the piece of depth information to obtain the focusing position regarding the target object.

According to an embodiment of the present invention, the processing unit further includes a block depth estimator. The block depth estimator selects a block containing the target object, reads pieces of depth information of a plurality of neighborhood pixels in the block, performs a statistical calculation on the pieces of depth information of the neighborhood pixels to obtain a piece of optimized depth information of the target object, and obtains the focusing position regarding the target object according to the piece of optimized depth information.

According to an embodiment of the present invention, the processing unit further includes an object tracking module. The object tracking module is coupled to the block depth estimator. The object tracking module tracks the target object to obtain at least one piece of characteristic information and a trajectory, wherein the piece of characteristic information includes gravity center information, color information, area information, contour information, or shape information. The block depth estimator performs the statistical calculation according to the pieces of characteristic information and depth information of the neighborhood pixels.

According to an embodiment of the present invention, the storage unit further includes a depth information database, and the processing unit further includes a displacement estimation module. The depth information database is configured to store the pieces of depth information corresponding to the target object at different time points. The displacement estimation module is coupled to the storage unit and the focusing module. The displacement estimation module performs a procedure of displacement estimation according to the pieces of depth information in the depth information database to obtain a depth variation trend regarding the target object, and the focusing module controls the first image sensor and the second image sensor to move smoothly according to the depth variation trend.

As described above, in an AF method and an AF apparatus provided by the present invention, a 3D depth map is generated through a stereoscopic image processing technique, and an optimization process is performed on the 3D depth map to obtain a focusing position. Thus, an AF action can be performed within a single image shooting period. Thereby, the AF apparatus and the AF method provided by the present invention offer a faster speed of auto focusing. Additionally, because it is not needed to search for the maximum focus value, the phenomenon of breathing is avoided, and accordingly the image stability is improved.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an auto focus (AF) apparatus according to an embodiment of the present invention.

FIG. 2 is a flowchart of an AF method according to an embodiment of the present invention.

FIG. 3 is a block diagram of a storage unit and a processing unit in the embodiment illustrated in FIG. 1.

FIG. 4 is a flowchart of an AF method according to another embodiment of the present invention.

FIG. 5 is a flowchart of a step for determining a piece of optimized depth information of a target object in the embodiment illustrated in FIG. 4.

FIG. 6 is a flowchart of an AF method according to yet another embodiment of the present invention.

### DESCRIPTION OF THE EMBODIMENTS

Reference will now be made in detail to the present preferred embodiments of the invention, examples of which are illustrated in the accompanying drawings.

Wherever possible, the same reference numbers are used in the drawings and the description to refer to the same or like parts.

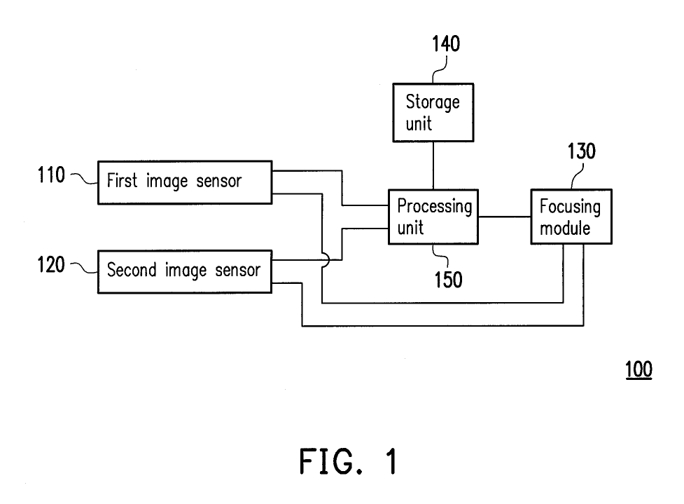

FIG. 1 is a block diagram of an auto focus (AF) apparatus according to an embodiment of the present invention. Referring to FIG. 1, the AF apparatus 100 in the present embodiment includes a first image sensor 110, a second image sensor 120, a focusing module 130, a storage unit 140, and a processing unit 150. In the present embodiment, the AF apparatus 100 is a digital camera, a digital video camcorder (DVC), or any other handheld electronic apparatus which can be used for capturing videos or photos. However, the type of the AF apparatus 100 is not limited in the present invention.

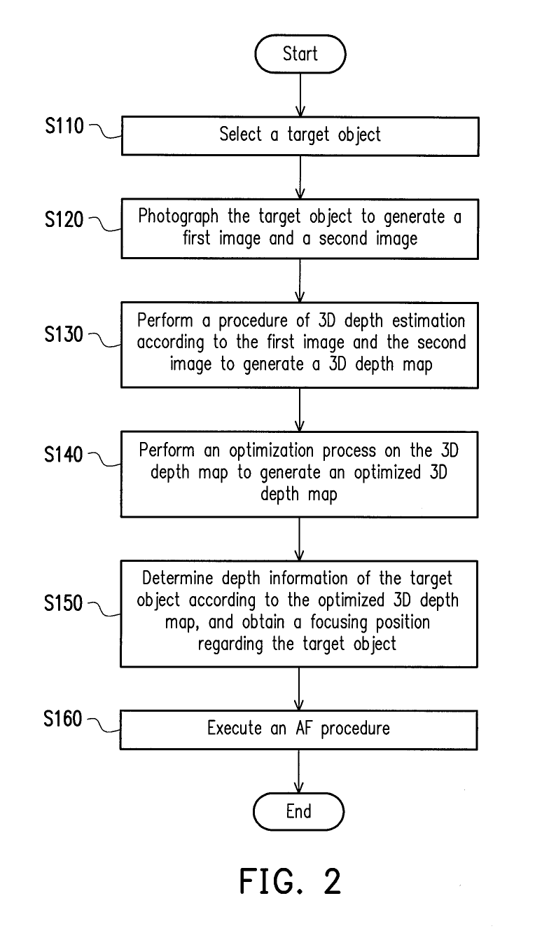

Referring to FIG. 1, in the present embodiment, the first image sensor 110 and the second image sensor 120 respectively might include elements, such as a lens; a photosensitive element, an aperture and so forth, which are used to capture images. Besides, the focusing module 130, the storage unit 140, and the processing unit 150 may be functional modules implemented as hardware and/or software, wherein the hardware may be any one or a combination of different hardware devices with image processing functions, such as a central processing unit (CPU), a system on chip (SOC), an application specific intergrated circuit (ASIC), a digital signal processor (DSP), a chipset, and a microprocessor, and the software may be an operating system (OS) or driver programs. In the present embodiment, the processing unit 150 is coupled to the first image sensor 110, the second image sensor 120, the focusing module 130, and the storage unit 140. The processing unit 150 controls the first image sensor 110, the second image sensor 120, and the focusing module 130 and stores related information into the storage unit 140. Below, the functions of different modules of the AF apparatus 100 in the present embodiment will be explained in detail with reference to FIG. 2.

FIG. 2 is a flowchart of an AF method according to an embodiment of the present invention. Referring to FIG. 2, the AF method in the present embodiment can be executed by the AF apparatus 100 illustrated in FIG. 1. Below, the AF method in the present embodiment will be described in detail with reference to different modules of the AF apparatus 100.

First, in step S110, a target object is selected. To be specific, in the present embodiment, a click signal for selecting the target object may be received from a user through the AF apparatus 100 to select the target object. For example, the user can select the target object through a touch action or by moving an image capturing apparatus to a specific area. However, the present invention is not limited thereto. In other embodiments, an object detecting procedure may be executed through the AF apparatus 100 to automatically select the target object and obtain a coordinate position of the target object. For example, the AF apparatus 100 can automatically select the target object and obtain the coordinate position thereof through face detection, smile detection, or subject detection. However, the present invention is not limited thereto, and those having ordinary knowledge in the art should be able to design the mechanism for selecting the target object in the AF apparatus 100 according to the actual requirement.

Then, in step S120, the target object is captured by using the first image sensor 110 and the second image sensor 120 to respectively generate a first image and a second image. For example, the first image is a left-eye image, and the second image is a right-eye image. In the present embodiment, the first image and the second image are stored in the storage unit 140 to be used in subsequent steps.

Next, in step S130, the processing unit 150 performs a procedure of 3D depth estimation according to the first image and the second image to generate a 3D depth map. To be specific, the processing unit 150 performs image processing through a stereoscopic vision technique to obtain a 3D coordinate position of the target object in the space and depth information of each point in the images. After obtaining the piece of initial depth information of each point, the processing unit 150 integrates all pieces of depth information into a 3D depth map.

Thereafter, in step S140, the processing unit 150 performs an optimization process on the 3D depth map to generate an optimized 3D depth map. To be specific, in the present embodiment, a weighted processing is performed on the piece of depth information of each point and the pieces of depth information of adjacent points through an image processing technique. For example, in the present embodiment, the optimization process is a Gaussian smoothing process. In short, during the Gaussian smoothing process, each pixel value is a weighted average of adjacent pixel values.

Since the original pixel has the maximum Gaussian distribution value, it has the maximum weight. As to the adjacent pixels, the farther a pixel is away from the original pixel, the smaller weight the pixel has. Thus, after the processing unit 150 performs the Gaussian smoothing process on the 3D depth map, the pieces of depth information of different points in the image can be more continuous, and meanwhile, the pieces of marginal depth information of the image can be maintained. Thereby, not only the problem of vague or discontinuous depth information carried by the 3D depth map can be avoided, but the holes in the 3D depth map can be fixed by using the pieces of depth information of adjacent points. However, even though the optimization process is assumed to be a Gaussian smoothing process in foregoing description, the present invention is not limited thereto. In other embodiments, those having ordinary knowledge in the art can perform the optimization process by using any other suitable statistical calculation method according to the actual requirement, which will not be described herein.

Next, in step S150, the processing unit 150 determines the piece of depth information corresponding to the target object according to the optimized 3D depth map and obtains a focusing position regarding the target object according to the piece of depth information. To be specific, to obtain the focusing position regarding the target object according to the piece of depth information, a depth table may be inquired according to the piece of depth information to obtain the focusing position regarding the target object. For example, while executing the AF procedure, the number of steps of a stepping motor or the magnitude of current of a voice coil motor in the AF apparatus 100 is controlled through the focusing module 130 to respectively adjust the zoom lenses of the first image sensor 110 and the second image sensor 120 to desired focusing positions, so as to focus. Thus, the relationship between the number of steps of the stepping motor or the magnitude of current of the voice coil motor and the clear depth of the target object can be determined in advance through an beforehand calibration procedure of the stepping motor or the voice coil motor, and the corresponding data can be recorded in the depth table and stored into the storage unit 140. Thereby, the number of steps of the stepping motor or the magnitude of current of the voice coil motor corresponding to current depth information of the target object can be obtained, and the focusing position regarding the target object can be obtained accordingly.

Next, in step S160, the processing unit 150 drives the AF apparatus 100 to execute an AF procedure according to the focusing position. To be specific, because the focusing module 130 controls the focusing positions of the first image sensor 110 and the second image sensor 120, after obtaining the focusing position regarding the target object, the processing unit 150 drives the focusing module 130 of the AF apparatus 100 to adjust the zoom lenses of the first image sensor 110 and the second image sensor 120 to this focusing position, so as to complete the AF procedure.

As described above, a 3D depth map is generated through a stereoscopic image processing technique, and an optimization process is then performed on the 3D depth map to obtain a focusing position. Through such a technique, the AF apparatus 100 and the AF method in the present embodiment can complete an AF procedure within a single image shooting period. Thus, the AF apparatus 100 and the AF method in the present embodiment offer a faster speed of auto-focusing. Additionally, the phenomenon of breathing is avoided in the AF apparatus 100 and the AF method in the present embodiment, and accordingly image stability is improved.

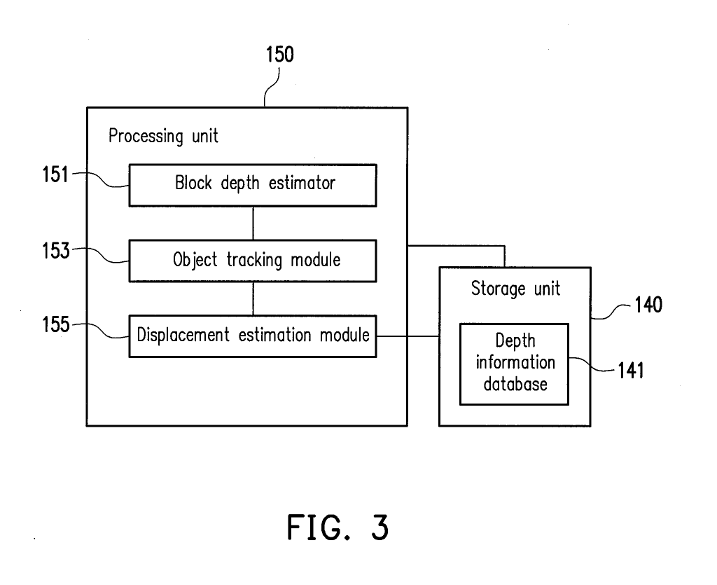

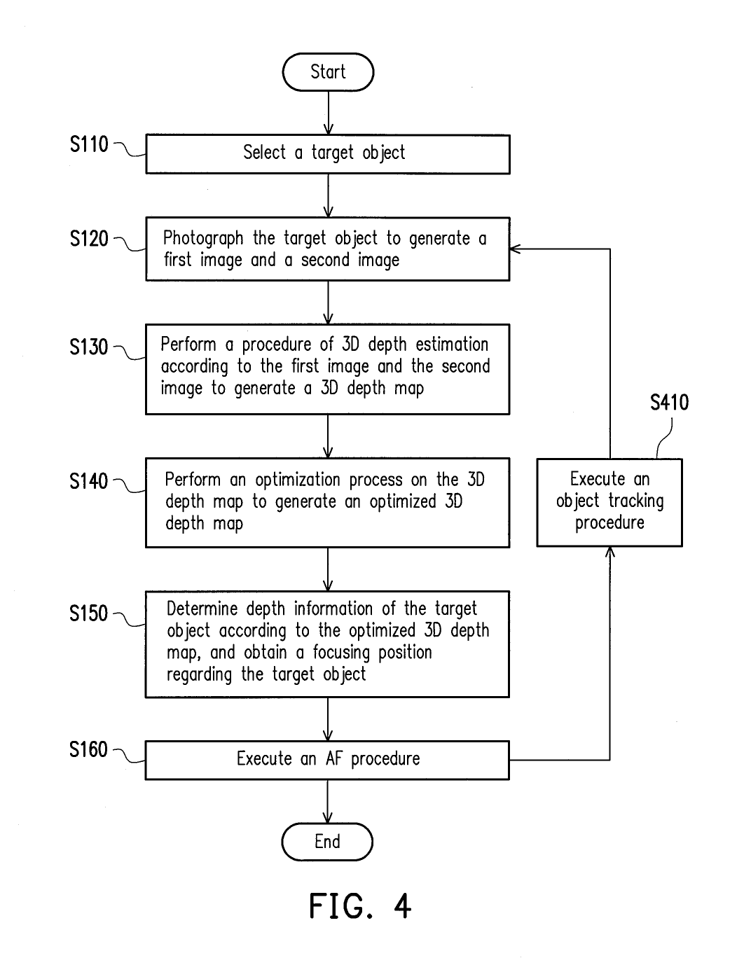

FIG. 3 is a block diagram of a storage unit and a processing unit in the embodiment illustrated in FIG. 1. Referring to FIG. 3, to be specific, in the present embodiment, the storage unit 140 of the AF apparatus 100 further includes a depth information database 141, and the processing unit 150 further includes a block depth estimator 151, an object tracking module 153, and a displacement estimation module 155. In the present embodiment, the block depth estimator 151, the object tracking module 153, and the displacement estimation module 155 may be functional blocks implemented as hardware and/or software, where the hardware may be any one or a combination of different hardware devices with image processing functions, such as a CPU, a system on chip (SOC), an application specific integrated circuit (ASIC), a digital signal processor (DSP), a chipset, and a microprocessor, and the software may be an OS or driver programs. Below, the functions of the block depth estimator 151, the object tracking module 153, the displacement estimation module 155, and the depth information database 141 in the present embodiment will be described in detail with reference to FIG. 4 to FIG. 6.

FIG. 4 is a flowchart of an AF method according to another embodiment of the present invention. Referring to FIG. 4, the AF method in the present embodiment may be executed by the AF apparatus 100 illustrated in FIG. 1 and the processing unit 150 illustrated in FIG. 3. The AF method in the present embodiment is similar to the AF method in the embodiment illustrated in FIG. 2, and only the differences between the two AF methods will be explained below.

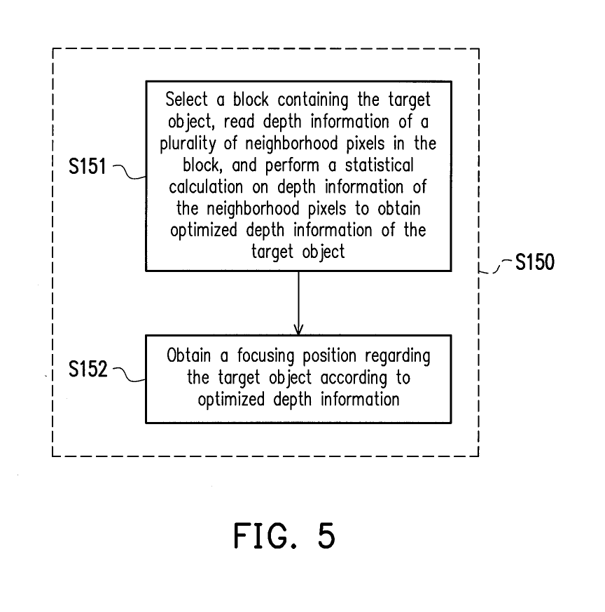

FIG. 5 is a flowchart of a step for determining a piece of optimized depth information of a target object in the embodiment illustrated in FIG. 4. Step 5150 of FIG. 4 (the piece of depth information corresponding to the target object is determined according to the optimized 3D depth map, and a focusing position regarding the target object is obtained according to the piece of depth information) further includes steps S151 and S152. Referring to FIG. 5, in step S151, through the block depth estimator 151, a block containing the target object is selected, the pieces of depth information of a plurality of neighborhood pixels in the block is read, and a statistical calculation is performed on the pieces of depth information of the neighborhood pixels to obtain a piece of optimized depth information of the target object. To be specific, the statistical calculation is performed to calculate the piece of valid depth information of the target object and avoid focusing on an incorrect object.

For example, the statistical calculation may be a mean calculation, a mod calculation, a median calculation, a minimum value calculation, a quartile calculation, or any other suitable statistical calculation. To be specific, the mean calculation is to use average depth information of the block as the piece of optimized depth information for executing subsequent AF steps. The mod calculation is to use the pieces of depth information of the greatest number in the block as the piece of optimized depth information. The median calculation is to use the median value of the pieces of depth information in the block as the piece of optimized depth information. The minimum value calculation is to use the shortest object distance in the block as the piece of optimized depth information. The quartile calculation is to use a first quartile or a second quartile of the pieces of depth information in the block as the piece of optimized depth information. However, the present invention is not limited thereto, and those having ordinary knowledge in the art can obtain the piece of optimized depth information of the target object by using any other suitable statistical calculation method according to the actual requirement, which will not be described herein.

Next, in step S152, a focusing position regarding the target object is obtained according to the piece of optimized depth information. In the present embodiment, the technique used in step S152 has been explained in detail in step S150 in the embodiment illustrated in FIG. 2 therefore will not be described herein.

Referring to FIG. 4 again, the AF method in the present embodiment further includes step S410, in which an object tracking procedure is executed on the target object through the object tracking module 153 to obtain at least one piece of characteristic information and a trajectory of the target object. To be specific, the piece of characteristic information of the target object includes gravity center information, color information, area information, contour information, or shape information. The object tracking module 153 extracts various elements for forming the target object from the first image and the second image by using different object tracking algorithm and then integrates these elements into the piece of characteristic information of a higher level. The object tracking module 153 tracks the target object by comparing the piece of characteristic information between continuous first images or second images generated at different time points. It should be noted that the object tracking algorithm is not limited in the present invention, and those having ordinary knowledge in the art can obtain the piece of characteristic information and the trajectory of the target object by using any suitable object tracking algorithm according to the actual requirement, which will not be described herein. In addition, the object tracking module 153 is further coupled to the block depth estimator 151 to send the piece of characteristic information and the trajectory back to the block depth estimator 151. The block depth estimator 151 further performs statistical calculations using different weighting techniques according to the piece of characteristic information of the target object, the reliability (similarity) of a tracked and estimated pixel, and the pieces of depth information of the neighborhood pixels to make the piece of optimized depth information of the target object more accurate.

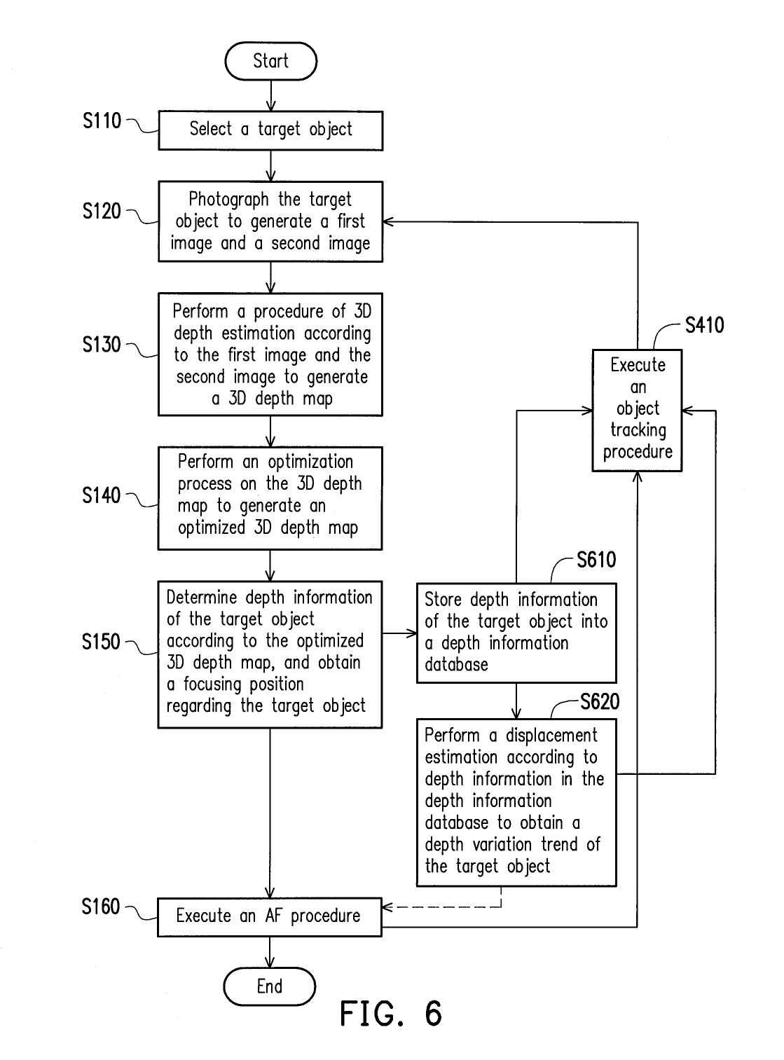

FIG. 6 is a flowchart of an AF method according to yet another embodiment of the present invention. Referring to FIG. 6, the AF method in the present embodiment can be executed by the AF apparatus 100 illustrated in FIG. 1 and the processing unit 150 illustrated in FIG. 3. The AF method in the present embodiment is similar to the AF method in the embodiment illustrated in FIG. 4. Below, only the differences between the two AF methods will be explained.

In the present embodiment, the AF method further includes steps S610 and S620. In step S610, the pieces of depth information of the target object at different time points is stored in the depth information database 141 through the storage unit 140 and the processing unit 150 (as shown in FIG. 3). To be specific, when the AF apparatus executes step S150, it constantly obtains pieces of 3D position information of the moving target object. Thus, the processing unit 150 can input and store the pieces of depth information of the target object at different time points into the depth information database 141 in the storage unit 140.

Next, in step S620, a procedure of displacement estimation is performed by the displacement estimation module 155 according to the pieces of depth information in the depth information database 141 to obtain a depth variation trend regarding the target object. To be specific, the displacement estimation module 155 is coupled to the storage unit 140 and the focusing module 130. When the displacement estimation module 155 performs the displacement estimation on the pieces of depth information in the depth information database 141, the displacement estimation module 155 obtains the 3D position information variation trend (particularly, the position variation trend of the target object along the axis Z of the target object, i.e., the depth variation trend of the target object) moving in the space, so that the position of the target object at the next instant can be estimated and the AF procedure can be carried out smoothly. To be specific, after obtaining the depth variation trend of the target object, the depth variation trend of the target object is transmitted to the focusing module 130, so that the focusing module 130 controls the first image sensor 110 and the second image sensor 120 to move smoothly according to the depth variation trend. To be more specific, before the focusing module 130 executes the AF procedure, the AF apparatus 100 adjusts the positions of the lenses of the first image sensor 110 and the second image sensor 120 according to the depth variation trend of the target object to make the lenses of the first image sensor 110 and the second image sensor 120 to be close to the focusing position obtained in step S150. Thereby the movement of the AF apparatus 100 when it executes the AF procedure in step S160 can be very smooth, and accordingly the stability of the AF apparatus 100 is improved.

Additionally, the depth information database 141 and the displacement estimation module 155 respectively send the pieces of depth information of the target object at different time points and the depth variation trend thereof back to the object tracking module 153. According to the depth variation trend and depth information of the target object, the object tracking module 153 performs calculations and analysis on the pieces of characteristic information and depth information further. Thereby, the burden of the system is reduced and the operation speed thereof is increased. Besides, result of the object tracking procedure is made very accurate, and the focusing performance of the AF apparatus 100 is improved.

As described above, in an AF method and an AF apparatus provided by embodiments of the present invention, a 3D depth map is generated through a stereoscopic image processing technique, and an optimization process is performed on the 3D depth map to obtain a focusing position. Thus, an AF procedure can be executed within a single image time. Thereby, the AF apparatus and the AF method provided by the present invention offer a fast focusing speed. Additionally, because it is not needed to search for the maximum focus value repeatedly, the phenomenon of breathing is avoided, and accordingly the image stability is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An auto focus (AF) method, adapted to an AF apparatus, wherein the AF apparatus comprises a first image sensor and a second image sensor, the AF method comprising:
selecting a target object, and photographing the target object by the first image sensor and the second image sensor to generate a first image and a second image;
performing a three-dimensional (3D) depth estimation according to the first image and the second image to generate a 3D depth map;
performing an optimization process on the 3D depth map to generate an optimized 3D depth map;
determining a piece of depth information corresponding to the target object according to the optimized 3D depth map, and obtaining a focusing position regarding the target object according to the piece of depth information; and
driving the AF apparatus to execute an AF procedure according to the focusing position.

2. The AF method as claimed in claim 1, wherein the step of obtaining the focusing position regarding the target object according to the piece of depth information comprises:
inquiring a depth table according to the piece of depth information to obtain the focusing position regarding the target object.

3. The AF method as claimed in claim 1, wherein the step of selecting the target object comprises:
receiving a click signal for selecting the target object from a user by using the AF apparatus or executing an object detecting procedure by using the AF apparatus to automatically select the target object, and obtaining a coordinate position of the target object.

4. The AF method as claimed in claim 1, wherein the step of determining the piece of depth information corresponding to the target object according to the optimized 3D depth map and obtaining the focusing position regarding the target object according to the piece of depth information comprises:
selecting a block containing the target object, reading pieces of depth information of a plurality of neighbour pixels in the block, performing a statistical calculation on the pieces of depth information of the neighbour pixels to obtain a piece of optimized depth information of the target object; and
obtaining the focusing position regarding the target object according to the piece of optimized depth information.

5. The AF method as claimed in claim 1 further comprising:
executing an object tracking procedure on the target object to obtain at least one piece of characteristic information and a trajectory of the target object, wherein the the piece of characteristic information comprises gravity center information, color information, area information, contour information, or shape information.

6. The AF method as claimed in claim 1 further comprising:
storing the pieces of depth information corresponding to the target object at different time points into a depth information database; and
performing a procedure of displacement estimation according to the pieces of depth information in the depth information database to obtain a depth variation trend regarding the target object.

7. The AF method as claimed in claim 1, wherein the optimization process is a Gaussian smoothing process.

8. An auto focus (AF) apparatus, comprising:
a first image sensor and a second image sensor, photographing a target object to generate a first image and a second image;
a focusing module, controlling a focusing position of the first image sensor and the second image sensor; and
a processing unit, coupled to the first image sensor, the second image sensor, and the focusing module, wherein the processing unit performs a three-dimensional (3D) depth estimation on the first image and the second image to generate a 3D depth map and performs an optimization process on the 3D depth map to generate an optimized 3D depth map, the processing unit determines a piece of depth information corresponding to the target object according to the optimized 3D depth map and obtains the focusing position regarding the target object according to the piece of depth information, and the focusing module executes an AF procedure according to the focusing position.

9. The AF apparatus as claimed in claim 8 further comprising:
a storage unit, coupled to the processing unit, and configured to store the first image, the second image, and a depth table,
wherein the processing unit inquires the depth table according to the piece of depth information to obtain the focusing position regarding the target object.

10. The AF apparatus as claimed in claim 8, wherein the processing unit further comprises:
a block depth estimator, selecting a block containing the target object, reading pieces of depth information of a plurality of neighborhood pixels in the block, performing a statistical calculation on the pieces of depth information of the neighborhood pixels to obtain a piece of optimized depth information of the target object, and obtaining the focusing position regarding the target object according to the piece of optimized depth information.

11. The AF apparatus as claimed in claim 10, wherein the processing unit further comprises:
an object tracking module, coupled to the block depth estimator, and tracking the target object to obtain at least one piece of characteristic information and a trajectory, wherein the piece of characteristic information comprises gravity center information, color information, an area information, contour information, or shape information, and the block depth estimator performs the statistical calculation according to the piece of characteristic information and depth information of the neighborhood pixels.

12. The AF apparatus as claimed in claim 9, wherein the storage unit further comprises a depth information database, the depth information database is configured to store the pieces of depth information corresponding to the target object at different time points, and the processing unit further comprises:
a displacement estimation module, coupled to the storage unit and the focusing module, performing a procedure of displacement estimation according to the pieces of depth information in the depth information database to obtain a depth variation trend regarding the target object, and the focusing module controls the first image sensor and the second image sensor to move smoothly according to the depth variation trend.
